(19) United States
(12) Patent Application Publication
(10) Pub. No.: US 2025/0105435 A1
(43) Pub. Date: Mar. 27, 2025

(54) METHOD OF MANUFACTURING CASE FOR SECONDARY BATTERY AND SECONDARY BATTERY

(71) Applicant: Prime Planet Energy & Solutions, Inc., Tokyo (JP)

(72) Inventors: Yukinobu MIYAMURA, Kobe-shi (JP); Ryoichi WAKIMOTO, Kobe-shi (JP); Hiroaki IMANISHI, Kobe-shi (JP)

(21) Appl. No.: 18/796,303

(22) Filed: Aug. 7, 2024

(30) Foreign Application Priority Data
Sep. 27, 2023 (JP) 2023-165254

(51) Int. Cl. H01M 50/342; H01M 50/103; H01M 50/119; H01M 50/15

(52) U.S. Cl. CPC H01M 50/3425; H01M 50/103; H01M 50/119; H01M 50/15

(57) ABSTRACT

A method of manufacturing a case for a secondary battery includes: bending a metal plate having a first end side and a second end side into a tubular shape such that the first end side and the second end side are close to each other; forming a joining portion that joins the first end side and the second end side to each other by applying a high-energy ray to the first end side and the second end side; and forming a fragile portion by applying the high-energy ray to the metal plate at a position separated from the first end side and the second end side.

### CROSS REFERENCE TO RELATED APPLICATIONS

This nonprovisional application is based on Japanese Patent Application No. 2023-165254 filed on Sep. 27, 2023 with the Japan Patent Office, the entire contents of which are hereby incorporated by reference.

### BACKGROUND OF THE INVENTION

### Field of the Invention

The present technology relates to: a method of manufacturing a case for a secondary battery; and the secondary battery.

### Description of the Background Art

Japanese Patent Laying-Open No. 8-148184 is a prior art document that discloses a non-aqueous electrolyte solution secondary battery. In the non-aqueous electrolyte solution secondary battery described in Japanese Patent Laying-Open No. 8-148184, a groove extending in a plurality of directions is formed in a flat prismatic battery container at its side surface not parallel to a positive electrode and a negative electrode.

Japanese Patent No. 5821605 is a prior art document that discloses a secondary battery. In the secondary battery described in Japanese Patent No. 5821605, a thin portion having a thickness less than those of the other portions of a metal plate in a case is formed as a safety valve at a location at which edge portions of the metal plate are welded to each other. The thin portion is formed by rolling, grinding, or the like.

### SUMMARY OF THE INVENTION

From the viewpoint of reliability in the secondary battery, each of the secondary batteries described in Japanese Patent Laying-Open No. 8-148184 and Japanese Patent No. 5821605 has room for improvement in efficient manufacturing of a secondary battery having high reliability.

The present technology has been made to solve the above-described problem and has an object to provide a secondary battery that has high reliability and that can be efficiently manufactured.

A method of manufacturing a case for a secondary battery according to the present technology includes: bending a metal plate having a first end side and a second end side into a tubular shape such that the first end side and the second end side are close to each other; forming a joining portion that joins the first end side and the second end side to each other by applying a high-energy ray to the first end side and the second end side; and forming a fragile portion by applying the high-energy ray to the metal plate at a position separated from the first end side and the second end side.

A secondary battery according to the present technology includes an electrode assembly and a case. The electrode assembly includes a first electrode and a second electrode having a polarity different from a polarity of the first electrode. The case accommodates the electrode assembly. The case includes an exterior package, a first sealing plate, and a second sealing plate. The exterior package is provided with a first opening and a second opening. The first opening is located at an end portion of the exterior package on a first side in a first direction. The second opening is located at an end portion of the exterior package on a second side opposite to the first side in the first direction. The first sealing plate seals the first opening. The second sealing plate seals the second opening. The exterior package is provided with a joining portion and a molten-solidified portion. The joining portion extends from the first opening to the second opening. The molten-solidified portion constitutes a fragile portion that is fractured when internal pressure of the case becomes equal to or more than a predetermined value and that discharges gas in the case to outside of the case. The exterior package has a first end side and a second end side joined at the joining portion. The molten-solidified portion is provided at a position separated from the first end side and the second end side.

The molten-solidified portion refers to a portion of the metal plate constituting the exterior package, the portion having been melted by application of a high-energy ray and then solidified.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to a first embodiment of the present technology.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a diagram showing a state in which the secondary battery shown in FIG. 1 is viewed in a direction of arrow V.

FIG. 6 is a front cross sectional view of the secondary battery shown in FIG. 1.

FIG. 7 is a front view showing a negative electrode raw plate before a negative electrode plate is formed.

FIG. 8 is a cross sectional view of the negative electrode raw plate shown in FIG. 7 along VIII-VIII.

FIG. 9 is a front view showing the negative electrode plate formed from the negative electrode raw plate.

FIG. 10 is a front view showing a positive electrode raw plate before a positive electrode plate is formed.

FIG. 11 is a cross sectional view of the positive electrode raw plate shown in FIG. 10 along XI-XI.

FIG. 12 is a front view showing the positive electrode plate formed from the positive electrode raw plate.

FIG. 13 is a flowchart showing a method of manufacturing a case main body included in the case for a secondary battery according to the first embodiment.

FIG. 14 is a diagram showing a metal plate constituting the case main body.

FIG. 15 is a diagram showing a state of bending the metal plate shown in FIG. 14.

FIG. 16 is a perspective view showing a state of forming a joining portion in the case main body.

FIG. 17 is a cross sectional view showing the state of forming the joining portion in the case main body.

FIG. 18 is a perspective view showing a state of forming a fragile portion in the case main body.

FIG. 19 is a cross sectional view of the case main body shown in FIG. 18 along XIX-XIX.

FIG. 20 is a cross sectional view of the case main body shown in FIG. 18 along XX-XX.

FIG. 21 is a cross sectional view showing a state of forming the fragile portion and a first region in the case main body.

FIG. 22 is a perspective view showing a configuration of the case main body when the fragile portion is fractured.

FIG. 23 is a top view showing a configuration of a case main body of a secondary battery according to a second embodiment.

FIG. 24 is a top view showing a range of rupture of the case main body according to the second embodiment.

FIG. 25 is a top view showing a configuration of a case main body of a secondary battery according to a third embodiment.

FIG. 26 is a top view showing a range of rupture of the case main body according to the third embodiment.

FIG. 27 is a top view showing a configuration of a case main body of a secondary battery according to a fourth embodiment.

FIG. 28 is a top view showing a range of rupture of the case main body according to the fourth embodiment.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45° ”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “secondary battery” is not limited to a lithium ion battery, and may include other secondary batteries such as a nickel-metal hydride battery and a sodium-ion battery. In the present specification, the term “electrode” may collectively represent a positive electrode and a negative electrode.

It should be noted that in each of the figures, the X direction is defined to represent a direction along a winding axis of an electrode assembly included in the secondary battery, the Y direction is defined to represent a short-side direction of the case when viewed in the X direction, and the Z direction is defined to represent a long-side direction of the case when viewed in the X direction. Further, in order to facilitate understanding of the present technology, the size of each configuration in the figures may be illustrated to be changed from its actual size. Further, in the figures, a sealing-plate-joining portion between a case main body and a sealing plate may not be shown.

Further, in the specification of the present application, the X direction is defined as a first direction in which a first opening and a second opening of the case main body are arranged side by side, the Y direction is defined as a third direction in which a first plate-shaped portion and a second plate-shaped portion of one first wall portion of a pair of first wall portions (first side surface portions) are arranged side by side, and the Z direction is defined as a second direction in which the pair of first wall portions (first side surface portions) are arranged side by side.

### First Embodiment

### (Overall Configuration of Battery)

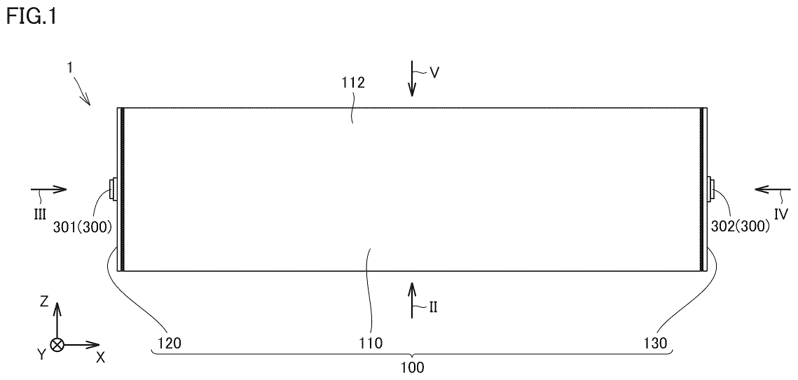

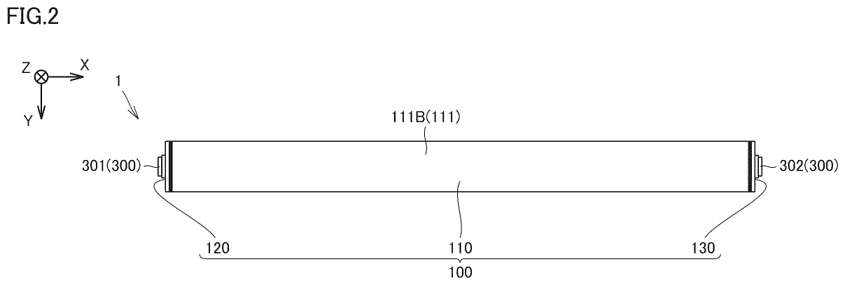

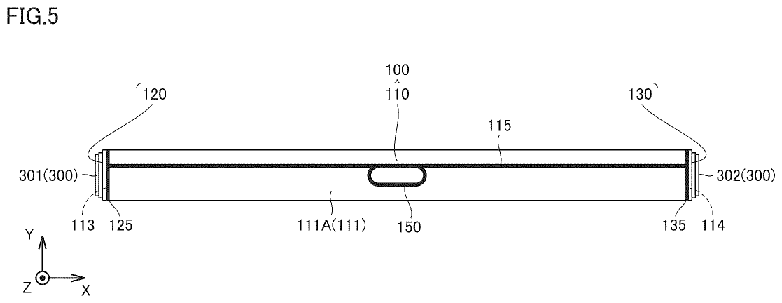

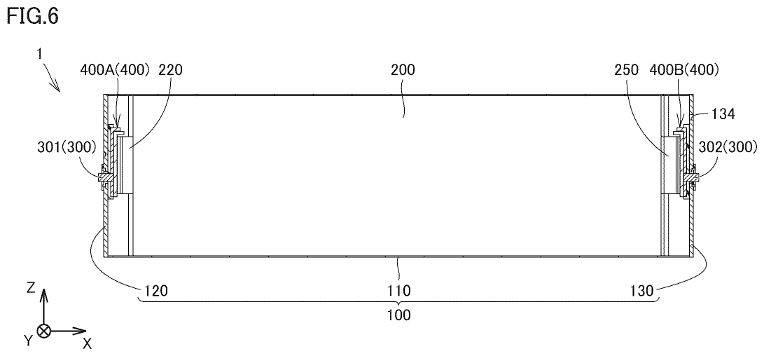

FIG. 1 is a front view of a secondary battery 1 according to the present embodiment. FIGS. 2 to 5 are diagrams showing states of secondary battery 1 shown in FIG. 1 when viewed in directions of arrows II, III, IV, and V respectively. FIG. 6 is a front cross sectional view of secondary battery 1 shown in FIG. 1.

Secondary battery 1 can be mounted on a battery electric vehicle (BEV), a plug-in hybrid electric vehicle (PHEV), a hybrid electric vehicle (HEV), or the like. It should be noted that the purpose of use of secondary battery 1 is not limited to the use on a vehicle.

As shown in FIGS. 1 to 6, secondary battery 1 includes a case 100, an electrode assembly 200, electrode terminals 300, and current collectors 400.

When forming a battery assembly including secondary battery 1, a plurality of secondary batteries 1 are stacked in the Y direction of each of the plurality of secondary batteries 1. Secondary batteries 1 stacked may be restrained in the stacking direction (Y direction) by a restraint member to form a battery module, or the battery assembly may be directly supported by a side surface of a case of a battery pack without using the restraint member.

Case 100 accommodates electrode assembly 200. Case 100 includes a case main body (exterior package) 110, a first sealing plate 120, and a second sealing plate 130.

Case main body 110 is constituted of a member having a tubular shape, preferably, a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like. When case main body 110 is composed of iron or an iron alloy, case main body 110 may be plated with nickel, tin, zinc, or the like.

As shown in FIGS. 1 and 2, first sealing plate 120 and second sealing plate 130 are provided at respective end portions of the case main body. Case main body 110 can be formed to have a prismatic tubular shape in, for example, the following manner: end sides of a plate-shaped member (metal plate) having been bent are brought into abutment with each other (joining portion 115 shown in FIG. 5) and are joined together (for example, laser welding). Each of the corners of the “prismatic tubular shape” may have a shape with a curvature.

In the present embodiment, case main body 110 is formed to be longer in the X direction of secondary battery 1 than in each of the Y direction and the Z direction of secondary battery 1. The size of case main body 110 in the X direction is preferably about 30 cm or more. In this way, secondary battery 1 can be formed to have a relatively large size (high capacity). The size of case main body 110 in the Z direction is preferably about 20 cm or less, more preferably about 15 cm or less, and further preferably about 10 cm or less. Thus, (low-height) secondary battery 1 having a relatively low height can be formed, thus resulting in improved ease of mounting on a vehicle, for example.

Case main body 110 includes a pair of first side surface portions 111 (a pair of first wall portions) and a pair of second side surface portions 112 (a pair of second wall portions). The pair of first side surface portions 111 are disposed to face each other in the second direction (Z direction) orthogonal to the first direction (X direction). The pair of first side surface portions 111 constitute the bottom surface portion and upper surface portion of case 100.

The pair of second side surface portions 112 face each other in the third direction (Y direction) orthogonal to the first direction (X direction) and the second direction (Z direction). The pair of second side surface portions 112 constitute parts of the side surfaces of case 100.

The pair of first side surface portions 111 and the pair of second side surface portions 112 are provided to intersect each other. The pair of first side surface portions 111 and the pair of second side surface portions 112 are connected at their respective end portions. As in the present embodiment, the area of each of the pair of first side surface portions 111 is preferably less than the area of each of the pair of second side surface portions 112.

As shown in FIG. 5, joining portion 115 is formed in one first side surface portion 111A of the pair of first side surface portions. Joining portion 115 extends from a first opening 113 to a second opening 114. That is, joining portion 115 extends in the X direction of secondary battery 1. In joining portion 115, the end sides of the metal plate constituting case main body 110 are joined to each other.

One first side surface portion 111A of the pair of first side surface portions is provided with a fragile portion 150. Fragile portion 150 is fractured when internal pressure of case 100 becomes equal to or more than a predetermined value, and discharges gas in case 100 to outside of case 100.

In the present embodiment, joining portion 115 and fragile portion 150 are provided in one first side surface portion 111A of the pair of first side surface portions. Details of joining portion 115 and fragile portion 150 will be described later.

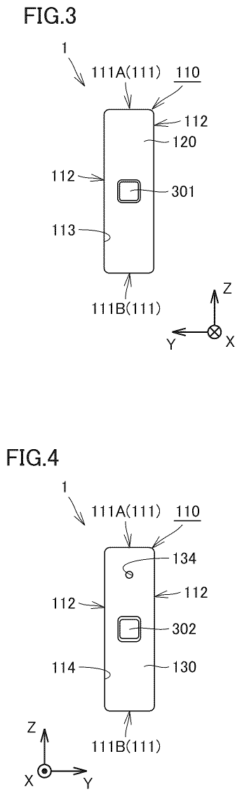

As shown in FIG. 3, first opening 113 is provided at an end portion of case main body 110 on a first side in the first direction (X direction). First opening 113 is sealed by first sealing plate 120. A sealing-plate-joining portion 125 is formed at first opening 113 so as to seal first opening 113. Each of first opening 113 and first sealing plate 120 has a substantially rectangular shape in which the Y direction corresponds to its short-side direction and the Z direction corresponds to its long-side direction.

A negative electrode terminal 301 (first electrode terminal) is provided on first sealing plate 120. Negative electrode terminal 301 in the present embodiment is located substantially at the center of first sealing plate 120 in each of the Y direction and the Z direction. It should be noted that the position of negative electrode terminal 301 can be appropriately changed.

As shown in FIG. 4, second opening 114 is provided at an end portion of case main body 110 on a second side opposite to the first side in the first direction (X direction). That is, second opening 114 is located at the end portion opposite to first opening 113. Second opening 114 is sealed by second sealing plate 130. A sealing-plate-joining portion 135 is formed at second opening 114 so as to seal second opening 114. Each of second opening 114 and second sealing plate 130 has a substantially rectangular shape in which the Y direction corresponds to its short-side direction and the Z direction corresponds to its long-side direction.

Second sealing plate 130 is provided with a positive electrode terminal 302 (second electrode terminal) and an injection hole 134. Positive electrode terminal 302 in the present embodiment is located substantially at the center of second sealing plate 130 in each of the Y direction and the Z direction. It should be noted that the positions of positive electrode terminal 302 and injection hole 134 can be appropriately changed.

Each of first sealing plate 120 and second sealing plate 130 is composed of a metal. Specifically, each of first sealing plate 120 and second sealing plate 130 is composed of aluminum, an aluminum alloy, iron, an iron alloy, or the like. When each of first sealing plate 120 and second sealing plate 130 is composed of iron or an iron alloy, first sealing plate 120 and second sealing plate 130 may be plated with nickel, tin, zinc, or the like.

Negative electrode terminal 301 is electrically connected to a negative electrode (first electrode) of electrode assembly 200. Negative electrode terminal 301 is attached to first sealing plate 120, i.e., case 100.

Positive electrode terminal 302 is electrically connected to a positive electrode (second electrode) of electrode assembly 200. Positive electrode terminal 302 is attached to second sealing plate 130, i.e., case 100.

Negative electrode terminal 301 is composed of a conductive material (more specifically, a metal), and can be composed of copper, a copper alloy, or the like, for example. A portion or layer composed of aluminum or an aluminum alloy may be provided at a portion of an outer surface of negative electrode terminal 301.

Positive electrode terminal 302 is composed of a conductive material (more specifically, a metal), and can be composed of aluminum, an aluminum alloy, or the like, for example.

Injection hole 134 is sealed by a sealing member (not shown). As the sealing member, for example, a blind rivet or another metal member can be used.

Electrode assembly 200 is an electrode assembly having a flat shape and having a below-described positive electrode plate and a below-described negative electrode plate. Specifically, electrode assembly 200 is a wound type electrode assembly in which a strip-shaped positive electrode plate and a strip-shaped negative electrode plate are both wound with a strip-shaped separator (not shown) being interposed therebetween. It should be noted that in the present specification, the “electrode assembly” is not limited to the wound type electrode assembly, and may be a stacked type electrode assembly in which a plurality of positive electrode plates and a plurality of negative electrode plates are alternately stacked. The strip-shaped separator can be constituted of, for example, a microporous membrane composed of polyolefin. The electrode assembly may include a plurality of positive electrode plates and a plurality of negative electrode plates, respective positive electrode tabs provided in the positive electrode plates may be stacked to form a positive electrode tab group, and respective negative electrode tabs provided in the negative electrode plates may be stacked to form a negative electrode tab group. It should be noted that electrode assembly 200 may include a plurality of wound type electrode assemblies or may include a plurality of stacked type electrode assemblies.

As shown in FIG. 6, case 100 accommodates electrode assembly 200. Electrode assembly 200 is accommodated in case 100 such that the winding axis thereof is parallel to the X direction.

Specifically, one or a plurality of the wound type electrode assemblies and an electrolyte solution (electrolyte) (not shown) are accommodated inside an insulating sheet (not shown) disposed in case 100. As the electrolyte solution (non-aqueous electrolyte solution), it is possible to use, for example, a solution obtained by dissolving LiPF₆ at a concentration of 1.2 mol/L in a non-aqueous solvent obtained by mixing ethylene carbonate (EC), ethyl methyl carbonate (EMC), and diethyl carbonate (DEC) at a volume ratio (25° C.) of 30:30:40. It should be noted that instead of the electrolyte solution, a solid electrolyte may be used.

Electrode assembly 200 includes: a main body portion (portion in which a positive electrode plate and a negative electrode plate are stacked with a separator being interposed therebetween); a first tab group 220 (negative electrode tab group); and a second electrode tab group 250 (positive electrode tab group).

The main body portion is constituted of a below-described negative electrode plate 210 (first electrode) and a below-described positive electrode plate 240 (second electrode). First electrode tab group 220 is located at an end portion thereof on the first sealing plate 120 side in the X direction with respect to the main body portion. Second electrode tab group 250 is located at an end portion of electrode assembly 200 on the second sealing plate 130 side with respect to the main body portion in the first direction (X direction).

Each of first electrode tab group 220 and second electrode tab group 250 is formed to protrude from a central portion of electrode assembly 200 toward first sealing plate 120 or second sealing plate 130.

Current collectors 400 include a negative electrode current collector 400A and a positive electrode current collector 400B. Each of negative electrode current collector 400A and positive electrode current collector 400B is constituted of a plate-shaped member. Electrode assembly 200 is electrically connected to negative electrode terminal 301 and positive electrode terminal 302 through current collectors 400.

Negative electrode current collector 400A is disposed on first sealing plate 120 with an insulating member composed of a resin being interposed therebetween. Negative electrode current collector 400A is electrically connected to first electrode tab group 220 and negative electrode terminal 301. Negative electrode current collector 400A is composed of a conductive material (more specifically, a metal), and can be composed of copper, a copper alloy, or the like, for example.

Positive electrode current collector 400B is disposed on second sealing plate 130 with an insulating member composed of a resin being interposed therebetween. Positive electrode current collector 400B is electrically connected to second electrode tab group 250 and positive electrode terminal 302. Positive electrode current collector 400B is composed of a conductive material (more specifically, a metal), and can be composed of aluminum, an aluminum alloy, or the like, for example. It should be noted that second electrode tab group 250 may be electrically connected to second sealing plate 130 directly or via positive electrode current collector 400B. In this case, second sealing plate 130 may serve as positive electrode terminal 302.

### (Configuration of Electrode Assembly 200)

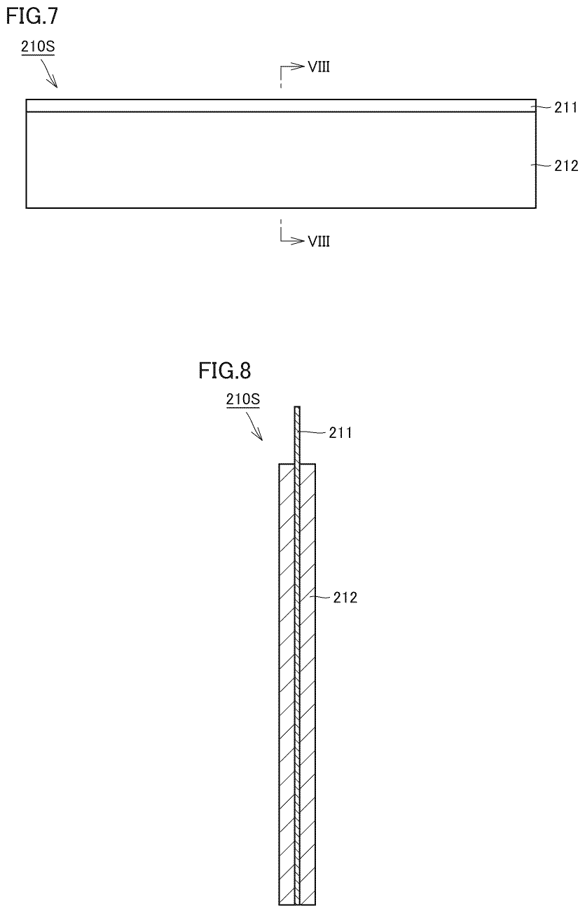

FIG. 7 is a front view showing a negative electrode raw plate 210S before negative electrode plate 210 is formed, FIG. 8 is a cross sectional view of negative electrode raw plate 210S shown in FIG. 7 along VIII-VIII, and FIG. 9 is a front view showing negative electrode plate 210 formed from negative electrode raw plate 210S.

Negative electrode plate 210 is manufactured by processing negative electrode raw plate 210S. As shown in FIGS. 7 and 8, negative electrode raw plate 210S includes a negative electrode core body 211 and a negative electrode active material layer 212. Negative electrode core body 211 is a copper foil or a copper alloy foil.

Negative electrode active material layer 212 is formed on negative electrode core body 211 except for each of end portions of both surfaces of negative electrode core body 211 on one side. Negative electrode active material layer 212 is formed by applying a negative electrode active material layer slurry using a die coater.

The negative electrode active material layer slurry is produced by kneading graphite serving as a negative electrode active material, styrene-butadiene rubber (SBR) and carboxymethyl cellulose (CMC) each serving as a binder, and water serving as a dispersion medium such that the mass ratio of the graphite, the SBR, and the CMC is about 98:1:1.

Negative electrode core body 211 having the negative electrode active material layer slurry applied thereon is dried to remove the water included in the negative electrode active material layer slurry, thereby forming negative electrode active material layer 212. Further, by compressing negative electrode active material layer 212, negative electrode raw plate 210S including negative electrode core body 211 and negative electrode active material layer 212 is formed. Negative electrode raw plate 210S is cut into a predetermined shape, thereby forming negative electrode plate 210. Negative electrode raw plate 210S can be cut by laser processing with application of an energy ray, die processing, cutter processing, or the like.

As shown in FIG. 9, a plurality of negative electrode tabs 230 each constituted of negative electrode core body 211 are provided at one end portion, in the width direction, of negative electrode plate 210 formed from negative electrode raw plate 210S. When negative electrode plate 210 is wound, the plurality of negative electrode tabs 230 are stacked to form first electrode tab group 220. Thus, first electrode tab group 220 is connected to negative electrode plate 210 (first electrode). The position of each of the plurality of negative electrode tabs 230 and the length thereof in the protruding direction are appropriately adjusted in consideration of the state in which first electrode tab group 220 is connected to negative electrode current collector 400A. It should be noted that the shape of negative electrode tab 230 is not limited to the one shown in FIG. 8.

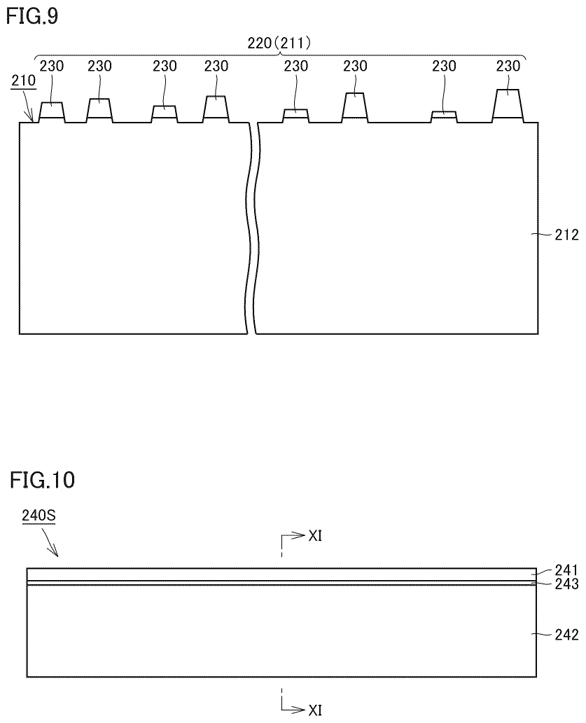

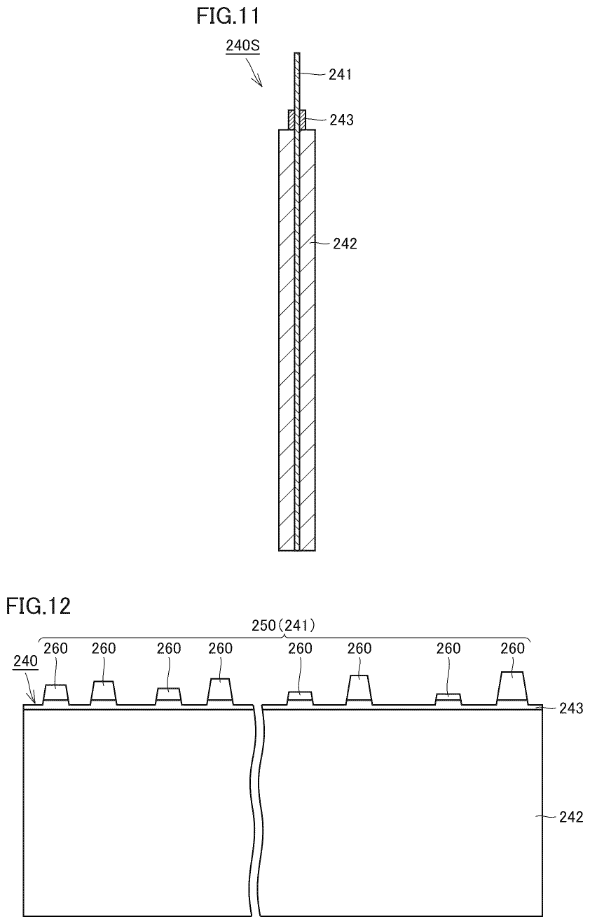

FIG. 10 is a front view showing a positive electrode raw plate 240S before positive electrode plate 240 is formed, FIG. 11 is a cross sectional view of positive electrode raw plate 240S shown in FIG. 10 along XI-XI, and FIG. 12 is a front view showing positive electrode plate 240 formed from positive electrode raw plate 240S.

Positive electrode plate 240 serving as the second electrode has a polarity different from a polarity of negative electrode plate 210 serving as the first electrode. Positive electrode plate 240 is manufactured by processing positive electrode raw plate 240S. As shown in FIGS. 10 and 11, positive electrode raw plate 240S includes a positive electrode core body 241, a positive electrode active material layer 242, and a positive electrode protective layer 243. Positive electrode core body 241 is an aluminum foil or an aluminum alloy foil.

Positive electrode active material layer 242 is formed on positive electrode core body 241 except for each of end portions of both surfaces of positive electrode core body 241 on one side. Positive electrode active material layer 242 is formed on positive electrode core body 241 by applying a positive electrode active material layer slurry using a die coater.

The positive electrode active material layer slurry is produced by kneading a lithium-nickel-cobalt-manganese composite oxide serving as a positive electrode active material, polyvinylidene difluoride (PVdF) serving as a binder, a carbon material serving as a conductive material, and N-methyl-2-pyrrolidone (NMP) serving as a dispersion medium such that the mass ratio of the lithium-nickel-cobalt-manganese composite oxide, the PVdF, and the carbon material is about 97.5:1:1.5.

Positive electrode protective layer 243 is formed in contact with positive electrode core body 241 at an end portion of positive electrode active material layer 242 on the one side in the width direction. Positive electrode protective layer 243 is formed on positive electrode core body 241 by applying a positive electrode protective layer slurry using a die coater. Positive electrode protective layer 243 has an electrical resistance larger than that of positive electrode active material layer 242.

The positive electrode protective layer slurry is produced by kneading alumina powder, a carbon material serving as a conductive material, PVdF serving as a binder, and NMP serving as a dispersion medium such that the mass ratio of the alumina powder, the carbon material, and the PVdF is about 83:3:14.

Positive electrode core body 241 having the positive electrode active material layer slurry and the positive electrode protective layer slurry applied thereon is dried to remove the NMP included in the positive electrode active material layer slurry and the positive electrode protective layer slurry, thereby forming positive electrode active material layer 242 and positive electrode protective layer 243. Further, by compressing positive electrode active material layer 242, positive electrode raw plate 240S including positive electrode core body 241, positive electrode active material layer 242, and positive electrode protective layer 243 is formed. Positive electrode raw plate 240S is cut into a predetermined shape, thereby forming positive electrode plate 240. Positive electrode raw plate 240S can be cut by laser processing with application of an energy ray, die processing, cutter processing, or the like.

As shown in FIG. 12, a plurality of positive electrode tabs 260 each constituted of positive electrode core body 241 are provided at one end portion, in the width direction, of positive electrode plate 240 formed from positive electrode raw plate 240S. When positive electrode plate 240 is wound, the plurality of positive electrode tabs 260 are stacked to form second electrode tab group 250. Thus, second electrode tab group 250 is connected to positive electrode plate 240 (second electrode). The position of each of the plurality of positive electrode tabs 260 and the length thereof in the protruding direction are appropriately adjusted in consideration of the state in which second electrode tab group 250 is connected to positive electrode current collector 400B. It should be noted that the shape of positive electrode tab 260 is not limited to the one shown in FIG. 12.

Positive electrode protective layer 243 is provided at the root of each of the plurality of positive electrode tabs 260. Positive electrode protective layer 243 may not necessarily be provided at the root of positive electrode tab 260.

In a typical example, the thickness of (one) negative electrode tab 230 is smaller than the thickness of (one) positive electrode tab 260. In this case, the thickness of first electrode tab group 220 is smaller than the thickness of second electrode tab group 250.

### (Production of Case Main Body 110)

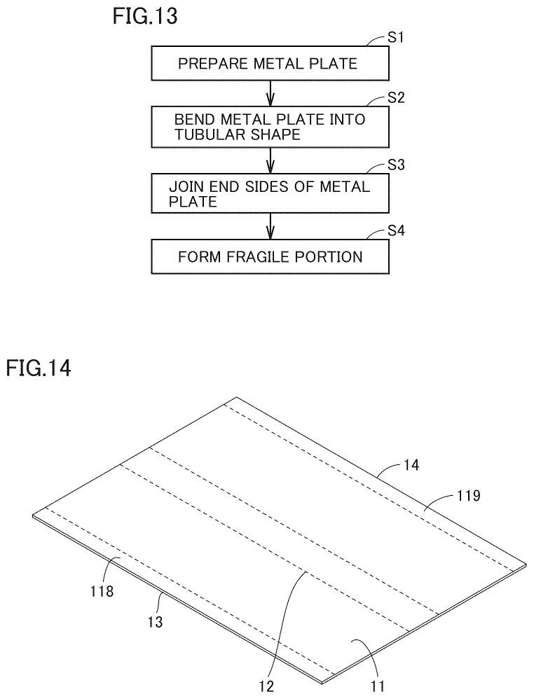

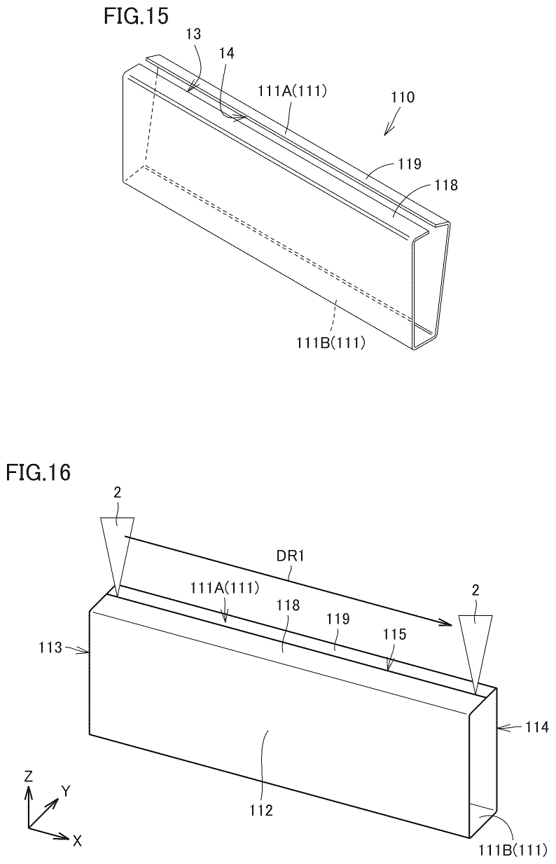

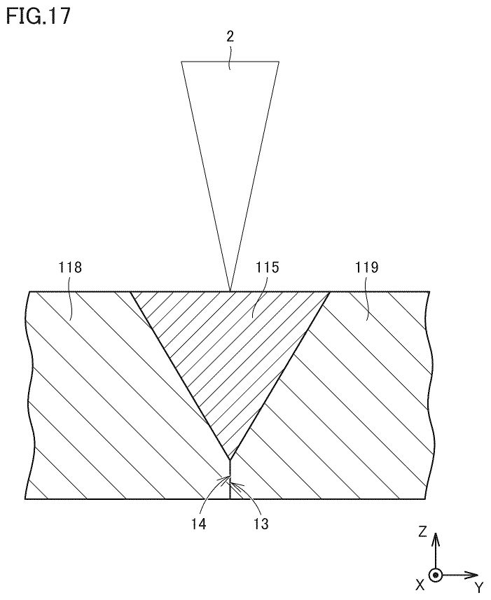

Hereinafter, a method of manufacturing a case main body (exterior package) included in a case for a secondary battery will be described. FIG. 13 is a flowchart showing the method of manufacturing a case main body included in a case for a secondary battery according to the first embodiment. FIG. 14 is a diagram showing a metal plate constituting the case main body. FIG. 15 is a diagram showing a state of bending the metal plate shown in FIG. 14. FIG. 16 is a perspective view showing a state of forming the joining portion in the case main body. FIG. 17 is a cross sectional view showing the state of forming the joining portion in the case main body.

As shown in FIGS. 13 and 14, first, metal plate 11 is prepared (step S1). Metal plate 11 preferably has a rectangular shape. Case main body 110 (exterior package) having a tubular shape is constituted of metal plate 11. In the present embodiment, one metal plate 11 constitutes case main body 110 (exterior package) having a tubular shape.

Metal plate 11 has a bent portion 12, a first end side 13, and a second end side 14. Metal plate 11 is bent along bent portion 12. Specifically, as shown in FIGS. 13 and 15, metal plate 11 is bent into a tubular shape such that first end side 13 and second end side 14 are close to each other (step S2).

As shown in FIGS. 13 and 15 to 17, next, a high-energy ray 2 is applied to first end side 13 and second end side 14, thereby forming joining portion 115 that joins first end side 13 and second end side 14 (step S3). In metal plate 11, first end side 13 and second end side 14, which are parallel to bent portion 12, are brought into abutment with each other, with the result that first plate-shaped portion 118 and second plate-shaped portion 119 of one first side surface portion 111A of the pair of first side surface portions are joined by joining portion 115. Thus, the tubular shape with the pair of first side surface portions 111 is formed.

High-energy ray 2 is, for example, laser. It should be noted that high-energy ray 2 is not limited to the laser, and may be an arc or the like. High-energy ray 2 is moved along a DR1 direction in FIG. 16. Joining portion 115 refers to a portion having been melted by application of high-energy ray 2 such as the laser and then solidified.

As shown in FIG. 17, first end side 13 and second end side 14 of metal plate 11 are preferably jointed with first end side 13 and second end side 14 being in abutment with each other. It should be noted that first end side 13 and second end side 14 of metal plate 11 may be joined with a clearance being interposed therebetween. The clearance is preferably less than 0.2 mm. Further, vicinities of first end side 13 and second end side 14 may be overlapped with each other in the thickness direction of metal plate 11 and may be then joined to each other.

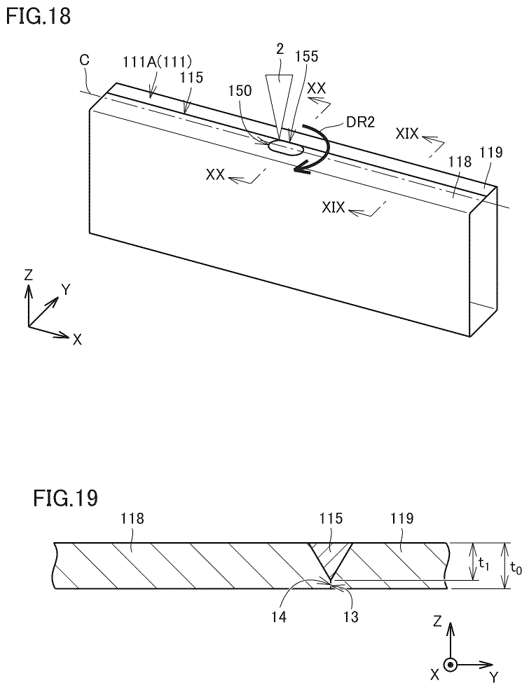

FIG. 18 is a perspective view showing a state of forming the fragile portion in the case main body. As shown in FIGS. 13 and 18, next, high-energy ray 2 is applied to metal plate 11 so as to form fragile portion 150 (step S4). Fragile portion 150 is constituted of a molten-solidified portion having been melted by application of high-energy ray 2 and then solidified.

Joining portion 115 includes a first region 155. First region 155 is a portion to which high-energy ray 2 is applied again after joining portion 115 is formed. First region 155 in the present embodiment is located at a central portion of joining portion 115 in the first direction (X direction). First region 155 extends in the form of a straight line in the first direction (X direction).

Fragile portion 150 (molten-solidified portion) is formed at a position separated from first end side 13 and second end side 14. In the present embodiment, fragile portion 150 is formed such that a portion thereof is connected to first region 155.

It should be noted that a whole of fragile portion 150 does not need to be separated from first end side 13 and second end side 14. However, the whole of fragile portion 150 may be provided at the position separated from first end side 13 and second end side 14. Alternatively, no first region 155 may be provided and a portion of fragile portion 150 may be connected to joining portion 115.

Fragile portion 150 and first region 155 are formed by applying high-energy ray 2 in a single stroke (in a direction along a DR2 direction in FIG. 18). Fragile portion 150 and first region 155 can be efficiently formed by applying high-energy ray 2 in a single stroke. It should be noted that fragile portion 150 and first region 155 may be formed separately by high-energy ray 2. When fragile portion 150 and first region 155 are formed separately, either joining portion 115 or fragile portion 150 may be formed first. Further, when fragile portion 150 is formed by high-energy ray 2, high-energy ray 2 does not necessarily need to be applied in a single stroke.

At least a portion of fragile portion 150 is located on a center line C extending along the first direction (X direction) through the center of one first side surface portion 111A of the pair of first side surface portions in the third direction (Y direction) orthogonal to the first direction (X direction) and the second direction (Z direction). When internal pressure of case 100 is increased, the surfaces of case 100 are expanded in the form of a sphere (circular arc). At one first side surface portion 111A of the first side surface portions in which joining portion 115 is located, stress is most likely to be concentrated on center line C in the Y direction in response to the internal pressure, and an amount of deformation is large. By providing fragile portion 150 on center line C in the Y direction, fragile portion 150 can be readily fractured.

Fragile portion 150 in the present embodiment is located at the central portion of one first side surface portion 111A of the pair of first side surface portions in the first direction (X direction). At one first side surface portion 111A of the first side surface portions in which joining portion 115 is located, stress is most likely to be concentrated on the central portion in the X direction in response to the internal pressure and an amount of deformation is large. By providing fragile portion 150 at the central portion in the X direction, fragile portion 150 can be readily fractured.

In the present embodiment, first region 155 is fractured prior to fragile portion 150. In the present embodiment, joining portion 115 constitutes a first molten-solidified portion, fragile portion 150 constitutes a second molten-solidified portion, and first region 155 constitutes a third molten-solidified portion.

A portion constituted of fragile portion 150 and first region 155 has a substantially annular shape when viewed in the second direction (Z direction). Since the portion constituted of fragile portion 150 and first region 155 has no angular portion, stress concentration is suppressed at the time of deformation during the fracture. Therefore, the fracture is likely to take place along the shape of fragile portion 150. That is, fragile portion 150 is likely to be fractured as designed in shape.

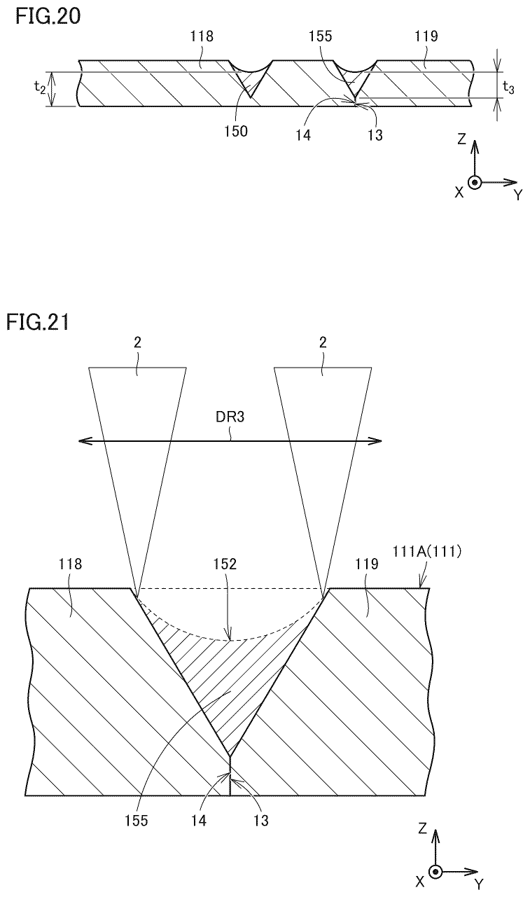

FIG. 19 is a cross sectional view of the case main body shown in FIG. 18 along XIX-XIX. FIG. 20 is a cross sectional view of the case main body shown in FIG. 18 along XX-XX.

As shown in FIG. 19, a depth of joining of joining portion 115 is adjusted in accordance with a condition such as an output or an operation speed of high-energy ray 2. Specifically, the depth of joining portion 115 is adjusted such that a thickness t₁ of joining portion 115 satisfies a relation of t₀≥t₁ with a thickness to of each of first plate-shaped portion 118 and second plate-shaped portion 119.

As shown in FIG. 20, fragile portion 150 is recessed on the outer surface side of one first side surface portion 111A of the pair of first side surface portions. A thickness t₂ of fragile portion 150 is less than thickness t₁ of joining portion 115. As with fragile portion 150, first region 155 is recessed on the outer surface side of one first side surface portion 111A of the pair of first side surface portions. A thickness t₃ of first region 155 is equal to or less than thickness t₂ of fragile portion 150.

In view of the above, thickness to of one first side surface portion 111A of the pair of first side surface portions, thickness t₁ of joining portion 115, thickness t₂ of fragile portion 150, and thickness t₃ of first region 155 satisfy the following relation: t₀≥t₁>t₂≥t₃.

The depth of the recess of each of fragile portion 150 and first region 155 is preferably 5% or more and 40% or less, and more preferably 25% of thickness to of one first side surface portion 111A of the pair of first side surface portions.

FIG. 21 is a cross sectional view showing a state of forming the first region in the case main body. As shown in FIG. 21, in order to attain a thinner thickness of first region 155 than those of the other portions, first region 155 is formed while wobbling high-energy ray 2 (swinging high-energy ray 2 leftward/rightward in the present embodiment). The laser is moved in a formation direction (X direction) for first region 155 while moving the laser back and forth in a DR3 direction in FIG. 21. An undercut, which is essentially regarded as a defect in welding, is formed intentionally, thereby forming a location having a thickness thinner than the thickness of one first side surface portion 111A of the pair of first side surface portions. It should be noted that fragile portion 150 is also formed by application of laser in the same manner as first region 155.

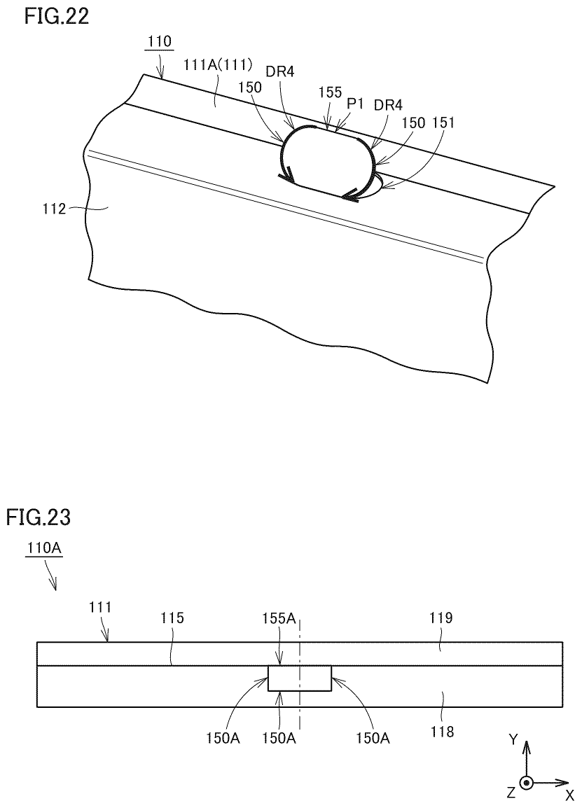

FIG. 22 is a perspective view showing a configuration of the case main body when the fragile portion is fractured. As shown in FIG. 22, when pressure in case 100 is increased, first region 155 becomes a fracture start position P1. First region 155 becomes fracture start position P1 because the thickness of first region 155 is the thinnest in case main body 110.

When the fracture is started from fracture start position P1, a through hole 151 is formed in case main body 110. Specifically, the fracture is progressed from fracture start position P1 to the whole of first region 155. Gas is discharged from the fractured portion immediately after the fracture, thereby decreasing the internal pressure of case 100. While the internal pressure of case 100 is decreased, force for expanding the fractured portion during the discharging of gas is applied to a periphery of the fractured portion. Thus, the fracture of fragile portion 150 adjacent to first region 155 is progressed (in directions DR4 in FIG. 22) until through hole 151 has a certain area. The gas is discharged from through hole 151 to outside of case 100.

In the present embodiment, through hole 151 is formed in a state in which a portion of case main body 110 surrounded by first region 155 and fragile portion 150 is not separated from case main body 110 and is connected to case main body 110. Thus, release of the gas can be directed. It should be noted that the portion of case main body 110 surrounded by first region 155 and fragile portion 150 may be separated from case main body 110.

On the other hand, joining portion 115 adjacent to the fractured portion may be fractured to some extent but has a shape that is not less likely to contribute to increase of the cross sectional area of the gas-discharge path, and is therefore fractured slightly as compared with fragile portion 150.

In each of the method of manufacturing a case for a secondary battery and secondary battery 1 according to the first embodiment of the present technology, high-energy ray 2 is applied to metal plate 11 constituting case main body 110 (exterior package), thereby forming: joining portion 115 that joins first end side 13 and second end side 14 of metal plate 11; and fragile portion 150 that is separated from first end side 13 and second end side 14 and that discharges gas when pressure in case 100 is increased so as to improve reliability of secondary battery 1. As compared with a case where a fragile portion such as a groove formed by a method other than application of high-energy ray 2 is formed, fragile portion 150 can be efficiently provided because the same processing method using high-energy ray 2 can be employed to join the portions of case main body 110 (exterior package) and form fragile portion 150. As a result, secondary battery 1 that has high reliability and that can be efficiently manufactured can be provided.

In each of the method of manufacturing a case for a secondary battery and secondary battery 1 according to the first embodiment of the present technology, since joining portion 115 and fragile portion 150 are provided on the same plane in case main body 110 (exterior package), joining portion 115 and fragile portion 150 can be efficiently provided by high-energy ray 2 without changing the posture of case main body 110, with the result that secondary battery 1 can be efficiently manufactured.

In each of the method of manufacturing a case for a secondary battery and secondary battery 1 according to the first embodiment of the present technology, joining portion 115 is formed to include first region 155 to which high-energy ray 2 is applied again after joining portion 115 is formed, and fragile portion 150 is formed to be connected to first region 155. Thus, case main body 110 is readily fractured with first region 155 serving as fracture start position P1 of case main body 110 (exterior package), thereby facilitating discharging of the gas in case 100.

In each of the method of manufacturing a case for a secondary battery and secondary battery 1 according to the first embodiment of the present technology, since the portion constituted of fragile portion 150 and first region 155 has a substantially annular shape when viewed in the second direction (Z direction), a large opening area of through hole 151 for discharging the gas in response to the fracture of fragile portion 150 and first region 155 can be secured readily as compared with a case where the portion has another shape (for example, a shape of line).

In each of the method of manufacturing a case for a secondary battery and secondary battery 1 according to the first embodiment of the present technology, since at least a portion of fragile portion 150 is located on center line C extending along the first direction (X direction) through the center of one first side surface portion 111A of the pair of first side surface portions (first wall portions) in the third direction (Y direction), fragile portion 150 is provided in case 100 at a position at which an amount of deformation in response to pressure of the gas is large, with the result that fragile portion 150 can be readily fractured.

In each of the method of manufacturing a case for a secondary battery and secondary battery 1 according to the first embodiment of the present technology, since fragile portion 150 is provided in case main body 110 at one first side surface portion 111A of the pair of first side surface portions (first wall portions) each having an area smaller than that of each of the pair of second side surface portions 112 (second wall portions), gas generated in case 100 can be facilitated to be discharged without interfering another secondary battery 1 even when a plurality of secondary batteries 1 are stacked with pairs of second side surface portions 112 of the plurality of secondary batteries 1 facing each other.

In each of the method of manufacturing a case for a secondary battery and secondary battery 1 according to the first embodiment of the present technology, since the area and position of the fracture in case 100 can be specified by providing fragile portion 150, discharging of gas in secondary battery 1 can be readily designed.

In each of the method of manufacturing a case for a secondary battery and secondary battery 1 according to the first embodiment of the present technology, a secondary battery 1 having the same size and a different amount of discharging of gas by changing the specification of secondary battery 1 can be manufactured simply by changing a processing condition for high-energy ray 2 for forming fragile portion 150 and first region 155. This leads to an improved speed in development of secondary battery 1, thereby suppressing cost of a mold for manufacturing of case 100.

Hereinafter, secondary batteries according to second to fourth embodiments will be described. Since the secondary battery according to each of these embodiments is different from secondary battery 1 according to the first embodiment of the present technology in terms of the configurations of the joining portion and the fragile portion of the case main body, the same configurations as those of secondary battery 1 according to the first embodiment of the present technology will not be described repeatedly.

### Second Embodiment

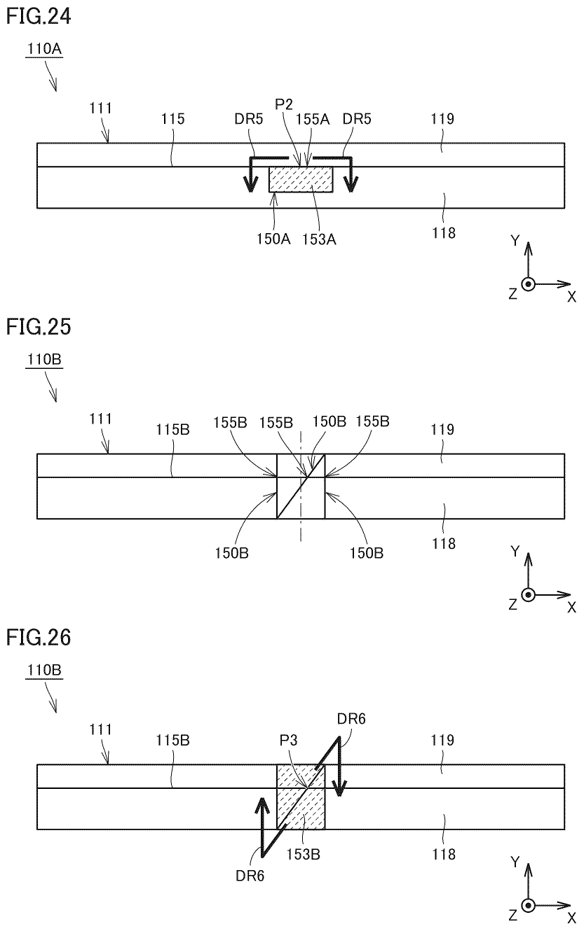

FIG. 23 is a top view showing a configuration of a case main body of the secondary battery according to the second embodiment. FIG. 24 is a top view showing a range of rupture of the case main body according to the second embodiment.

As shown in FIGS. 23 and 24, the secondary battery according to the present embodiment includes a case main body 110A (exterior package). Case main body 110A is provided with a fragile portion 150A and a first region 155A. A portion constituted of fragile portion 150A and first region 155A has a rectangular shape when viewed in the second direction (Z direction). First region 155A is one of the four sides of the rectangular shape.

When pressure in the case is increased, first region 155A becomes a fracture start position P2. When the fracture is started from fracture start position P2, the fracture is progressed to a whole of first region 155A and the fracture is progressed along DR5 directions of fragile portion 150A. Due to the fracture of fragile portion 150A, the gas is discharged to outside of the case. Since the portion constituted of fragile portion 150A and first region 155A has a rectangular shape, a range of rupture 153A corresponds to a range of the rectangular portion.

In each of the method of manufacturing a case for a secondary battery and the secondary battery according to the second embodiment of the present technology, since the portion constituted of fragile portion 150A and first region 155A has a rectangular shape when viewed in the second direction (Z direction), fragile portion 150A and first region 155A can be formed by applying the high-energy ray in a single stroke, with the result that fragile portion 150A and first region 155A can be efficiently formed. It should be noted that the high-energy ray is not necessarily applied in a single stroke.

In each of the method of manufacturing a case for a secondary battery and the secondary battery according to the second embodiment of the present technology, since the portion constituted of fragile portion 150A and first region 155A has a rectangular shape, case main body 110A is fractured straightly, with the result that an area of rupture can be readily designed.

In each of the method of manufacturing a case for a secondary battery and the secondary battery according to the second embodiment of the present technology, since the portion constituted of fragile portion 150A and first region 155A has a rectangular shape, a large range of rupture 153A can be readily secured as compared with a case where the portion has another shape (for example, a shape of line).

### Third Embodiment

FIG. 25 is a top view showing a configuration of the case main body of the secondary battery according to the third embodiment. FIG. 26 is a top view showing a range of rupture of the case main body according to the third embodiment.

As shown in FIGS. 25 and 26, the secondary battery according to the present embodiment includes a case main body 110B (exterior package). Case main body 110B is provided with a fragile portion 150B and first regions 155B. A portion constituted of fragile portion 150B and first regions 155B has a substantially N shape when viewed in the second direction (Z direction).

Fragile portion 150B is constituted of: one side extending through a portion of joining portion 115B in a direction inclined with respect to the X direction; and two sides extending from respective ends of the one side in the Y direction to intersect joining portion 115B substantially orthogonally. Each of first regions 155B is located at an intersection between a joining portion 115B extending in the first direction (X direction) and fragile portion 150B formed to have a substantially N shape.

When pressure in the case is increased, first region 155B becomes a fracture start position P3. In the present embodiment, fracture occurs at fracture start position P3 close to the center of first region 155B in the first direction (X direction). When the fracture is started from fracture start position P3, the fracture is progressed along DR6 directions of fragile portion 150B. Due to the fracture of fragile portion 150B, gas is discharged to outside of the case. Since the portion constituted of fragile portion 150B and first regions 155B has a substantially N shape, a range of rupture 153B corresponds to a range of a substantially rectangular portion surrounded by the substantially N shape.

In each of the method of manufacturing a case for a secondary battery and the secondary battery according to the third embodiment of the present technology, since the portion constituted of fragile portion 150B and first regions 155B has a substantially N shape when viewed in the second direction (Z direction), fragile portion 150B and first regions 155B can be formed by applying the high-energy ray in a single stroke, with the result that fragile portion 150B and first regions 155B can be efficiently formed. It should be noted that the high-energy ray is not necessarily applied in a single stroke.

In each of the method of manufacturing a case for a secondary battery and the secondary battery according to the third embodiment of the present technology, since the portion constituted of fragile portion 150B and first regions 155B has a substantially N shape when viewed in the second direction (Z direction), the whole of the perimeter of the range of rupture 153B is not surrounded by fragile portion 150B and first regions 155B, thereby suppressing fracture that leads to separation of fragile portion 150B and first regions 155B from case main body 110B. Thus, risk of burst of the case can be reduced.

In each of the method of manufacturing a case for a secondary battery and the secondary battery according to the third embodiment of the present technology, since the portion constituted of fragile portion 150B and first region 155B has a substantially N shape when viewed in the second direction (Z direction), a large range of rupture 153B can be readily secured as compared with a case where the portion has another shape (for example, a shape of line).

### Fourth Embodiment

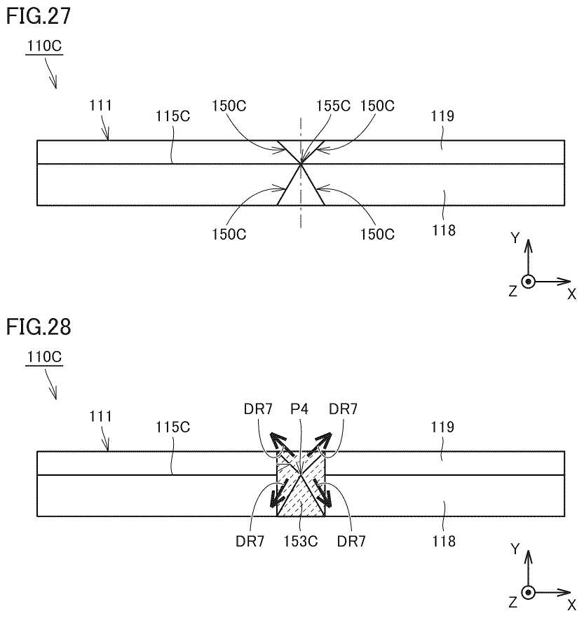

FIG. 27 is a top view showing a configuration of the case main body of the secondary battery according to the fourth embodiment. FIG. 28 is a top view showing a range of rupture of the case main body according to the fourth embodiment.

As shown in FIGS. 27 and 28, the secondary battery according to the present embodiment includes a case main body 110C (exterior package). Case main body 110C is provided with a fragile portion 150C and a first region 155C. A portion constituted of fragile portion 150C and first region 155C has a substantially X shape when viewed in the second direction (Z direction).

Fragile portion 150C is constituted of four sides extending, from the vicinity of the center in the third direction (Y direction), in four directions inclined with respect to the first direction (X direction) and the third direction (Y direction). Fragile portion 150C extends from the vicinity of the center in the Y direction to both ends of the pair of first side surface portions 111. First region 155C is located at an intersection between a joining portion 115C extending in the first direction (X direction) and fragile portion 150C formed to have a substantially X shape.

First region 155C is preferably disposed at the center in the X direction. Further, fragile portion 150C is preferably line-symmetrical with respect to a center line extending in the X direction through the center of each of the pair of first side surface portions 111 in the Y direction. Thus, case main body 110C can be readily fractured uniformly in the pair of first side surface portions 111.

When pressure in the case is increased, first region 155C becomes a fracture start position P4. When fracture is started from fracture start position P4, the fracture is progressed along DR7 directions of fragile portion 150C. Due to the fracture of fragile portion 150C, gas is discharged to outside of the case. Since the portion constituted of fragile portion 150C and first region 155C has a substantially X shape, the range of rupture 153C corresponds to a range of a substantially rectangular portion surrounded by the substantially X shape.

In each of the method of manufacturing a case for a secondary battery and the secondary battery according to the fourth embodiment of the present technology, since the portion constituted of fragile portion 150C and first region 155C has a substantially X shape when viewed in the second direction (Z direction), the whole of the perimeter of the range of rupture 153C is not surrounded by fragile portion 150C and first region 155C, thereby suppressing fracture that leads to separation of fragile portion 150C and first region 155C from case main body 110C. Thus, risk of burst of the case can be reduced.

In each of the method of manufacturing a case for a secondary battery and the secondary battery according to the fourth embodiment of the present technology, since the portion constituted of fragile portion 150C and first region 155C has a substantially X shape when viewed in the second direction (Z direction), a large range of rupture 153C can be readily secured as compared with a case where the portion has another shape (for example, a shape of line).

In each of the method of manufacturing a case for a secondary battery and the secondary battery according to the fourth embodiment of the present technology, since the portion constituted of fragile portion 150C and first region 155C has a substantially X shape when viewed in the second direction (Z direction), fragile portion 150C can be simultaneously fractured at four locations, thus resulting in an improved speed of fracture.

It has been illustratively described that in the secondary battery according to each of the above-described embodiments, the joining portion and the fragile portion of the case main body are connected to each other by the first region; however, it is not limited to this configuration. The joining portion and the fragile portion of the case main body may be formed on the same plane in the case main body so as to be separated from each other. Further, the joining portion and the fragile portion of the case main body may be formed on different planes in the case main body so as to be separated from each other. Even when the joining portion and the fragile portion are formed on the same plane in the case main body so as to be separated from each other or when the joining portion and the fragile portion are formed on different planes in the case main body so as to be separated from each other, the same processing method using a high-energy ray can be employed to provide the joining portion and the fragile portion, with the result that a secondary battery having high reliability can be efficiently provided.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A method of manufacturing a case for a secondary battery, the method comprising:
bending a metal plate having a first end side and a second end side into a tubular shape such that the first end side and the second end side are close to each other;
forming a joining portion that joins the first end side and the second end side to each other by applying a high-energy ray to the first end side and the second end side; and
forming a fragile portion by applying the high-energy ray to the metal plate at a position separated from the first end side and the second end side.

2. The method of manufacturing a case for a secondary battery according to claim 1, wherein
an exterior package having a tubular shape is constituted of the metal plate,
the exterior package is provided with
a first opening located at an end portion of the exterior package on a first side in a first direction,
a second opening located at an end portion of the exterior package on a second side opposite to the first side in the first direction, and
a pair of first wall portions facing each other in a second direction orthogonal to the first direction, and
the joining portion and the fragile portion are provided in one first wall portion of the pair of first wall portions.

3. The method of manufacturing a case for a secondary battery according to claim 2, wherein the fragile portion is formed to be connected to the joining portion.

4. The method of manufacturing a case for a secondary battery according to claim 2, wherein
the joining portion includes a first region to which the high-energy ray is applied again after the joining portion is formed, and
the fragile portion is formed to be connected to the first region.

5. The method of manufacturing a case for a secondary battery according to claim 4, wherein a portion constituted of the fragile portion and the first region has a substantially annular shape when viewed in the second direction.

6. The method of manufacturing a case for a secondary battery according to claim 4, wherein a portion constituted of the fragile portion and the first region has a substantially N shape when viewed in the second direction.

7. The method of manufacturing a case for a secondary battery according to claim 4, wherein a portion constituted of the fragile portion and the first region has a substantially X shape when viewed in the second direction.

8. The method of manufacturing a case for a secondary battery according to claim 2, wherein at least a portion of the fragile portion is located on a center line extending along the first direction through a center of the one first wall portion of the pair of first wall portions in a third direction orthogonal to the first direction and the second direction.

9. The method of manufacturing a case for a secondary battery according to claim 2, wherein
the exterior package has a pair of second wall portions facing each other in a third direction orthogonal to the first direction and the second direction, and
an area of each of the pair of first wall portions is less than an area of each of the pair of second wall portions.

10. A secondary battery comprising:
an electrode assembly including a first electrode and a second electrode having a polarity different from a polarity of the first electrode; and
a case that accommodates the electrode assembly, wherein
the case includes
an exterior package that is provided with a first opening located at an end portion of the exterior package on a first side in a first direction and a second opening located at an end portion of the exterior package on a second side opposite to the first side in the first direction,
a first sealing plate that seals the first opening, and
a second sealing plate that seals the second opening,
the exterior package is provided with a joining portion extending from the first opening to the second opening, and a molten-solidified portion constituting a fragile portion that is fractured when internal pressure of the case becomes equal to or more than a predetermined value and that discharges gas in the case to outside of the case,
the exterior package has a first end side and a second end side joined at the joining portion, and
the molten-solidified portion is provided at a position separated from the first end side and the second end side.

11. The secondary battery according to claim 10, wherein
the exterior package has a pair of first wall portions facing each other in a second direction orthogonal to the first direction, and
the joining portion and the fragile portion are provided in one first wall portion of the pair of first wall portions.

12. The secondary battery according to claim 11, wherein the fragile portion is formed to be connected to the joining portion.

13. The secondary battery according to claim 11, wherein
the joining portion includes a first region to which a high-energy ray is applied again after the joining portion is formed, and
the fragile portion is formed to be connected to the first region.

14. The secondary battery according to claim 13, wherein a portion constituted of the fragile portion and the first region has a substantially annular shape when viewed in the second direction.

15. The secondary battery according to claim 13, wherein a portion constituted of the fragile portion and the first region has a substantially N shape when viewed in the second direction.

16. The secondary battery according to claim 13, wherein a portion constituted of the fragile portion and the first region has a substantially X shape when viewed in the second direction.

17. The secondary battery according to claim 11, wherein at least a portion of the fragile portion is located on a center line extending along the first direction through a center of the one first wall portion of the pair of first wall portions in a third direction orthogonal to the first direction and the second direction.

18. The secondary battery according to claim 11, wherein
the exterior package has a pair of second wall portions facing each other in a third direction orthogonal to the first direction and the second direction, and
an area of each of the pair of first wall portions is less than an area of each of the pair of second wall portions.
